(19) United States
(12) Patent Application Publication
(10) Pub. No.: US 2008/0175179 A1
(43) Pub. Date: Jul. 24, 2008

(54) CONTENT PROCESSING APPARATUS AND CONTENT PROCESSING PROGRAM

(75) Inventors: Takuya Sakamoto, Kawasaki (JP); Shinji Tsutsumi, Kawasaki (JP); Hajime Katsumata, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/017,914

(22) Filed: Jan. 22, 2008

(30) Foreign Application Priority Data
Jan. 23, 2007 (JP) 2007-012917

(51) Int. Cl. H04B 7/00

(52) U.S. Cl. 370/310

(57) ABSTRACT

An apparatus for facilitating use of a remote controller with content from the internet. The apparatus preferably includes a remote controller that transmits control information corresponding to an operation to a main unit by wireless connection, where the main unit is equipped with a communication interface which can receive content and can process the content according to the control information received from the remote controller, a recognition information acquisition section acquires recognition information for recognizing a site to which the content belongs, a site recognition section recognizes the site based on the recognition information, an association section that associates the control information received from the remote controller with a script function of the site according to the recognized site, and a function invoking section that invokes a function associated with the control information received from the remote controller.

### TECHNICAL FILED

The present invention relates to a content processing apparatus which is equipped with a remote controller and that processes a content delivered via the Internet and content processing program executed by the content processing apparatus when a personal computer (hereinafter, abbreviated as a “PC”) equipped with a remote controller and connected to the Internet is used as the content processing apparatus which processes content received via the Internet. The content processing program may be recorded, for example, on a recording medium, or on another type of fixed or portable memory.

### BACKGROUND OF INVENTION

In recent years, a content delivery service which delivers music content or movie content via the Internet is becoming widespread. This content delivery service is normally available by connecting a PC to the Internet and installing a Web browser in the PC. Furthermore, for example, a PC provided with a remote controller which transmits control information corresponding to the operation to the PC main unit by means of infrared rays or the like is also becoming popular in recent years. Examples of methods used to operate a Web browser from a remote controller include a method of moving the focus of a link or a button using a Move key of the remote controller while watching the display screen of a PC, selecting the focused link or button by depressing an Enter key or a method of moving a mouse cursor using a Move key of the remote controller, depressing an Enter key and thereby selecting a link or button connected by the mouse cursor.

However, according to these methods, it is necessary to depress the remote controller many times to select a link or button or the like, which results in a complicated operation. Therefore, these methods are not suitable for usage whereby the same operation like pausing or rewinding a content such as a movie downloaded via the Internet is repeated many times.

On the other hand, the remote controller is normally provided with operation keys such as a play button, stop button, rewind button and fast forward button. However, when those operation keys are depressed, content downloaded via the Internet normally does not know to which script function in the content the control information corresponds, and if left as it is, the content cannot understand the control information even if the control information is transmitted to the PC by operating the remote controller.

As means for solving this problem, Patent Document 1 (Japanese Patent Laid-Open No. 10-98654) proposes to embed information on the correspondence between control information and script function in a Web page and transmit the information.

However, since the author of a Web page is normally different from the author of a browser, it is difficult to request that information on the correspondence thereof be embedded in a Web page for a specific browser.

Furthermore, according to the technique in above described Patent Document 1, there is a possibility that, for example, when a Play button of the remote controller is operated, the control information may be associated with a hidden function on the Internet, for example, some billing acceptance processing (accepting a purchase of an article or service), thus leading to a creation of a Web page with illegal purposes.

### SUMMARY

According to an aspect of one embodiment of the invention, an example apparatus comprises:

A remote controller that is equipped with a plurality of operators and that transmits control information corresponding to an operation to a main unit by wireless connection.

The main unit equipped with a communication interface which can receive a content delivered from a site on the network and which processes the content according to the control information received from the remote controller.

A recognition information acquisition section that acquires recognition information for recognizing a site to which the content delivered via the network belongs.

A site recognition section that recognizes the site to which the content delivered via the network belongs based on the recognition information.

An association section that associates the control information received from the remote controller with a script function of the site according to the recognized site.

A function invoking section that invokes a function associated with the control information received from the remote controller.

### BRIEF DESCRIPTION OF THE DRAWINGS

FIG. 1 is an overall configuration of an image display system including a PC which operates as a first embodiment of a content processing apparatus of the present invention;

FIG. 2 is an overall configuration of the image display system including a PC which operates as the first embodiment of the content processing apparatus of the present invention;

FIG. 3 is a plan view of a remote controller;

FIG. 4 shows a display image of a Web browser;

FIG. 5 shows a display image of a content “a” of a net movie service A;

FIG. 6 is a flow chart showing an overview of an image display program (Web browser) which is executed in the PC 50 shown in FIG. 1 and FIG. 2;

FIG. 7 is an overall configuration of an image display system including a PC which operates as a second embodiment of a content processing apparatus of the present invention;

FIG. 8 is an overall configuration of the image display system including a PC which operates as the second embodiment of the content processing apparatus of the present invention;

FIG. 9 is a flow chart of a part peculiar to the second embodiment; and

FIG. 10 shows a display example when information such as a title is acquired in addition.

### DETAILED DESCRIPTION OF THE EMBODIMENTS

Hereinafter, embodiments of the present invention will be explained.

First, an image display device will be explained. The image display device is, for example, a complex body of a PC with a remote controller and an image display program called a “Web browser” which is executed in the PC.

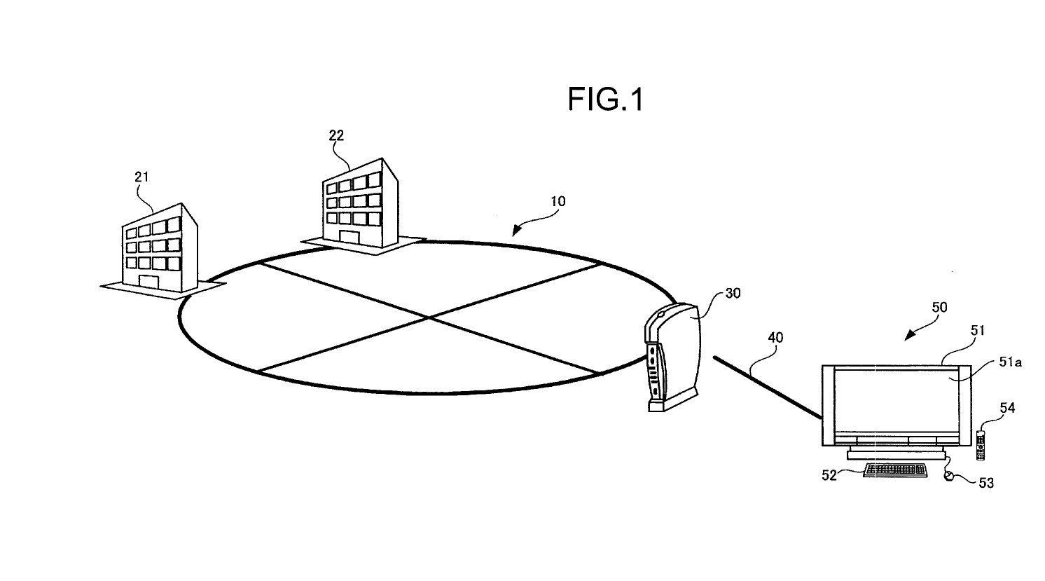

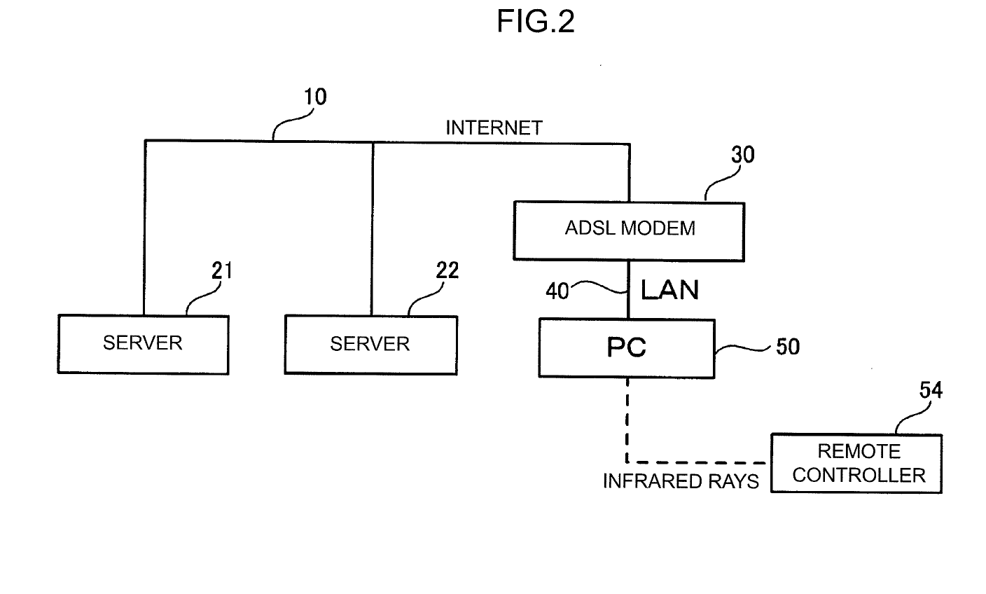

FIG. 1 and FIG. 2 show the overall configuration of an image display system including a PC which operates as one example of a first embodiment of a content processing apparatus of the present invention.

FIG. 1 shows the Internet 10; servers 21, 22 which provide a net movie service delivering movies via the Internet 10; an ADSL modem 30 for connection with a PC; and the PC 50 connected with the ADSL modem 30 by a LAN 40.

Here, the net movie service provided by the server 21 is called a “net movie service A.” Furthermore, the net movie service provided by the server 22 is called a “net movie service B.”

The PC 50 is equipped with publicly known elements such as a CPU and memory as the computer. Furthermore, in this embodiment, the PC 50 is equipped with a main unit 51 equipped with a display screen 51a on the front thereof, a keyboard 52, a mouse 53 and a remote controller 54. The main unit 51 is equipped with a communication interface which can receive content delivered from a site on the Internet, and which can process the content according to control information received from the remote controller. In FIG. 2, only the remote controller 54 out of the elements of the PC 50 is shown as a block different from the PC 50.

The remote controller 54 is provided with a plurality of keys (operators) and it transmits control information corresponding to an operation to the main unit by wireless connection. For example, it transmits control information corresponding to a key depressed to main unit 51 through an infrared communication.

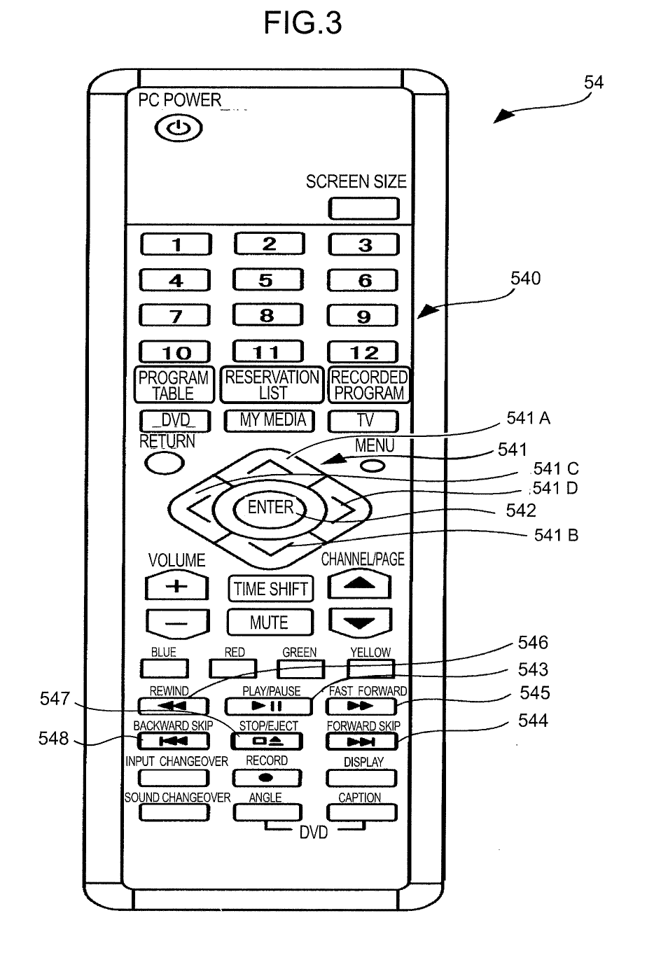

FIG. 3 is a plan view of an example of the remote controller.

The remote controller 54 is preferably provided with many keys, as shown in FIG. 3. According to this embodiment, the remote controller 54 is provided with a cross key 541 disposed substantially in the center of the remote controller 54, which consists of an UP key 541a, a DOWN key 541b, a LEFT key 541c, a RIGHT key 541d, and an ENTER key 542 disposed in the center of the cross key 541. Furthermore, according to this embodiment, the remote controller 54 is provided with a PLAY/PAUSE key 543, a STOP/EJECT key 547, a FAST FORWARD key 545, a REWIND key 546, a FORWARD SKIP key 544 and a BACKWARD SKIP key 548 at the positions under the cross key 541 and ENTER key 542.

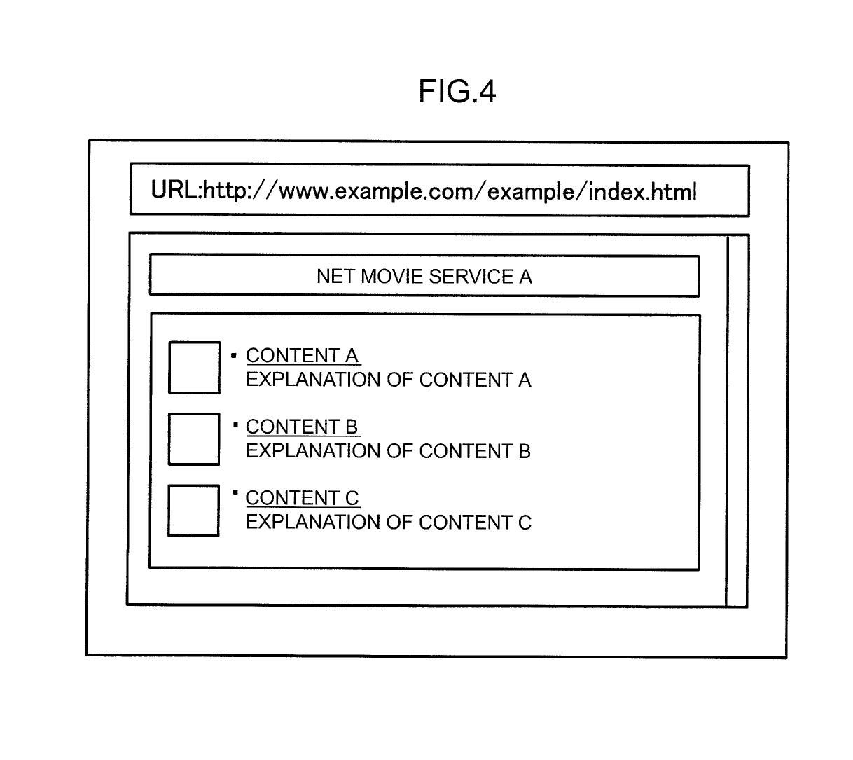

FIG. 4 shows a display image of a Web browser.

The display image shown in FIG. 4 is a net movie service A provided by the server 21 which is shown in FIG. 1 and FIG. 2. This net movie service A in this embodiment provides three movie contents of content a, content b and content c. The display image shown in FIG. 4 displays links to the contents a, b, c and an explanation consists of a title or overview of each content a, b, c or the like.

The user puts the focus on any one of the links to the contents a, b, c by operating the cross key 541 of the remote controller 54, depresses the ENTER key 542 and thereby selects the focused content. This causes a Web page of the selected content to be downloaded to the PC 50 from the server 21.

By way of explaining this embodiment, suppose the user has selected the content a.

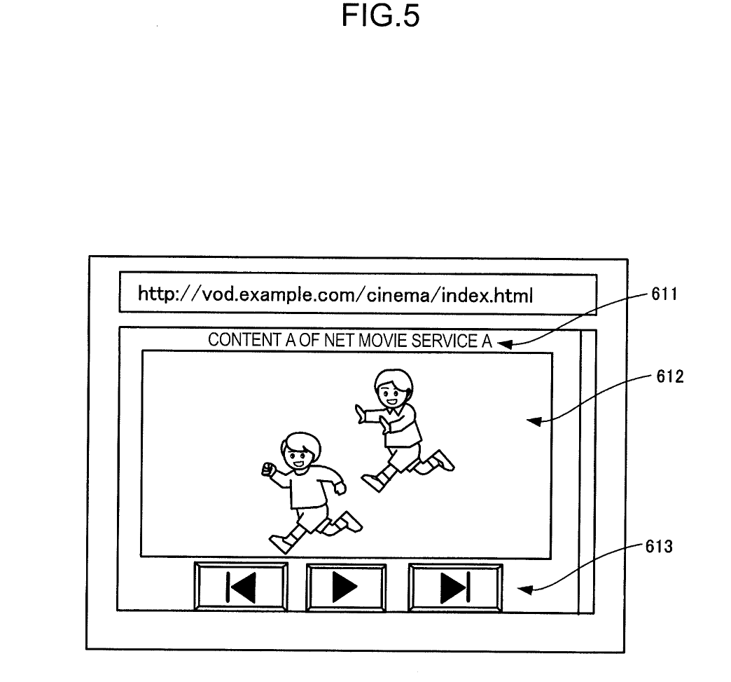

FIG. 5 shows a display image of the content a which belongs to the net movie service A.

FIG. 5 shows a display 611 indicating content a, which belongs to the net movie service A, an image 612 and three buttons 613. When the user selects any one of these buttons 613, the PC 50 performs a playback, stop or fast forwarding on content a. Furthermore, the three buttons 613 are shown in the example shown in FIG. 5, but when the user selects the PLAY button, the type of the button displayed varies depending on the situation then, for example, the display of the center one of the buttons 613 changes from the PLAY button to the STOP button.

This embodiment will be explained in comparison with a conventional case. When selecting these buttons 613 using a conventional remote controller, the user depresses a button corresponding to the cross key 541 shown in FIG. 3 to focus on a desired button. The user then depresses a button corresponding to the ENTER key 542 to select the focused button. In this way, an instruction for executing a playback, stop, fast forwarding or the like of the content is inputted to the PC.

In contrast, according to this embodiment, the user operates the PLAY/PAUSE key 543, STOP/EJECT key 544, FAST FORWARD key 545, REWIND key 546, FORWARD SKIP key 547 or BACKWARD SKIP key 548 of the remote controller 54 shown in FIG. 3 and thereby inputs an instruction for playback, stop, fast forwarding or the like to the PC.

That is, when using the conventional remote controller, even when the remote controller is equipped with various keys corresponding to the PLAY/PAUSE key 543, STOP/EJECT key 544, FAST FORWARD key 545, REWIND key 546, FORWARD SKIP key 547 and BACKWARD SKIP key 548, the user cannot input instructions executable by the PC such as playback, stop or fast forwarding on content downloaded via the Internet. This is because the conventional remote controller cannot resolve the correspondence between these various keys and the various types of processing such as playback, stop or fast forwarding on the content.

Therefore, even if the user operates various kinds of keys on the conventional remote controller, the PC cannot specify the processing which corresponds to the operated keys. This means that even if the user operates the PLAY key or the like on the conventional remote controller, the user cannot input any instruction executable by the PC.

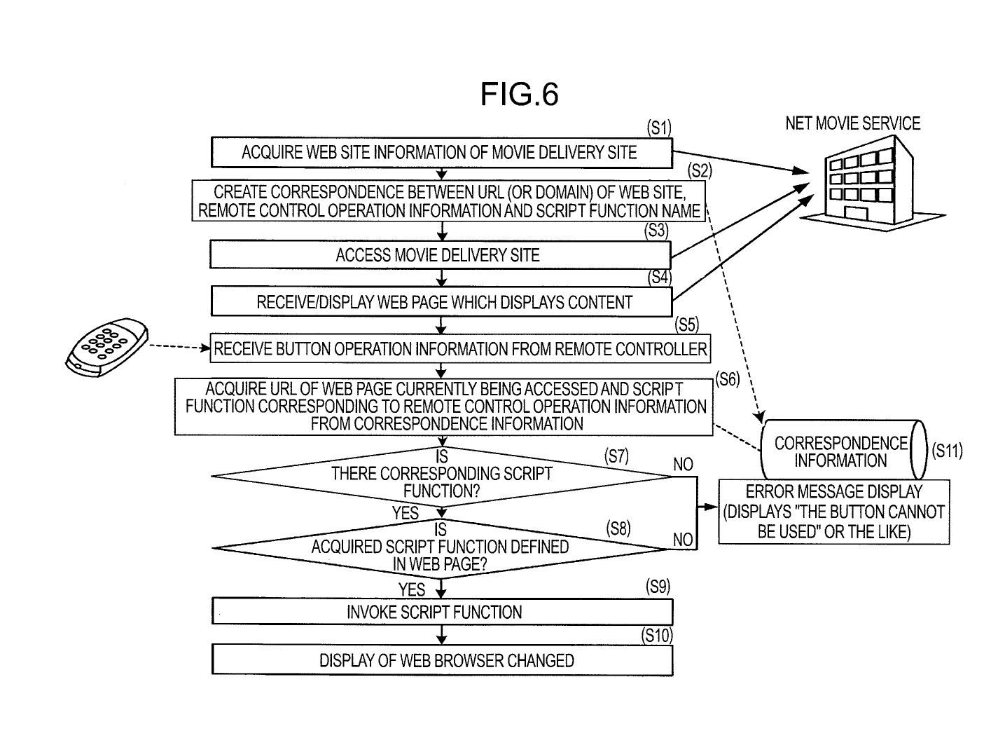

FIG. 6 is a flow chart showing an overview of the image display program (Web browser) executed in the PC 50 which is shown in FIG. 1 and FIG. 2. This image display program is an example of the content processing program referred to in the present specification.

When the execution of this image display program is started in the PC 50, the PC 50 acquires Web site information at a movie delivery site via the Internet 10 first (see FIG. 1, FIG. 2). This Web site information corresponds to an example of recognition information in the present invention. That is, the PC 50 acquires recognition information for recognizing the site to which a content delivered via the Internet belongs.

In this embodiment, the location of this Web site information is preset in the Web browser.

For example, when acquiring the Web site information of the server 21 shown in FIG. 1 and FIG. 2, the PC inquires the server 21 at URL of http://www.example.com/vod.xml. In this way, the PC acquires the following Web site information from the server 21:

<?xmlversion=“1.0”encoding=“Shift-JIS”?><allowRemoteControlList><domain>vod.example.com</domain></allowRemoteControlList>

The example of this Web site information shows “<domain>vod.example.com</domain>” as the statement describing a domain name. That is, “vod.example.com” becomes the domain name in this example. The Web site information of this example indicates that the Web page in the domain shown by the domain name “vod.example.com” is a Web page for the net movie service A.

Furthermore, <?xmlversion=“1.0”encoding=“Shift-JIS” ?><allowRemoteControlList><url>http://www.example.com/vod/</url></allowRemoteControlList> is shown as another example of the Web site information. This is an example where part of URL is described instead of the domain name. In this case, it indicates that the Web page which starts with “http://www.example.com/vod/” is the Web page for the net movie service A. Though the domain name is described in the XML format in this embodiment, the present invention does not depend on the format, tag name or the like. That is, it does not matter how recognition information (Web site information) is expressed.

Here, the acquisition of the Web site information of the net movie service A has been explained, but as for the net movie service B, the Web site information of the net movie service B can be acquired in the same way.

In this way, the PC 50 acquires Web site information about a plurality of sites and, in step S2 in FIG. 6, the PC 50 then associates URL (or domain) of the Web site with the operation information of the remote controller and the script function name. That is, the PC 50 associates the control information received from the remote controller with the script function of the site according to the recognized site.

In this embodiment, the following compatible table is preset in the Web browser.

TABLE 1

| | For movie delivery | For movie delivery |
|---|---|---|
| | service 1 | service 2 |
| Play button | RC_play ( ) | MoviePlay ( ) |
| Stop button | RC_stop ( ) | MovieStop ( ) |
| Pause button | RC_pause ( ) | MoviePause ( ) |
| Fast forward button | RC_ffwd ( ) | MovieForward ( ) |
| Rewind button | RC_rwd ( ) | MovieRewind ( ) |
| Forward skip button | RC_next ( ) | |
| Backward skip button | RC_prev ( ) | |

The net movie service A (for movie delivery service 1) will be explained. Table 1 shows that an RC_play( ) function is associated with the PLAY button of the remote controller, an RC_stop( ) function is associated with the STOP button, an RC_pause( ) function is associated with the PAUSE button, an RC_ffwd( ) function is associated with the FAST FORWARD button, an RC_rwd( ) function is associated with the REWIND button, an RC_next( ) function is associated with the FORWARD SKIP button and an RC_prev( ) function is associated with the BACKWARD SKIP button.

Next, the net movie service B (for movie delivery service 2) will be explained. Table 1 shows that a MoviePlay( ) function is associated with the PLAY button of the remote controller, a MovieStop( ) function is associated with the STOP button, a MoviePause( ) function is associated with the PAUSE button, a MovieForward( ) function is associated with the FAST FORWARD button and a MovieRewind( ) function is associated with the REWIND button. In the correspondence table for the movie delivery service 2 shown in Table 1 (the net movie service B provided by the server 22), the fields of the FORWARD SKIP button and the BACKWARD SKIP button of the remote controller are left blank. This means that no script function about the FORWARD SKIP button and the BACKWARD SKIP button is defined in the content of the net movie service B provided by the server 22 and that neither FORWARD SKIP nor BACKWARD SKIP is executed.

Though Table 1 shows the PLAY button and the PAUSE button separately, this does not impose any limitation that the remote controller 54 should be equipped with the two buttons of the PLAY button and the PAUSE button. In this embodiment, the PLAY/PAUSE key 543 provided for the remote controller 54 shown in FIG. 3 functions as the PLAY button and the PAUSE button. That is, this PLAY/PAUSE key 543 functions as a PLAY key during a stop or pause and functions as a PAUSE key during a playback. Furthermore, the STOP/EJECT key 544 of the remote controller 54 in FIG. 3 functions as a STOP key during a playback and functions as a key to eject a medium such a videotape or DVD during a stop.

Since movie content is downloaded via the Internet in this embodiment, no ejection operation is involved.

After acquiring the Web site information indicating whether or not it is the Web page of the net movie service in above described step S1, the flow moves to step S2 in FIG. 6.

In this embodiment, URL (http://www.example.com/vod.xml) indicating the location of the above described Web site information and the correspondence table in Table 1 are preset in the Web browser. The PC 50 associates the Web site information acquired via the Internet with the correspondence table in Table 1 based on a predetermined URL. That is, the field for the net movie service 1 of the correspondence table shown in Table 1 and the above described URL (http://www.example.com/vod.xml) are associated with each other in the Web browser. In this way, the PC 50 specifies a net movie service to which the Web page acquired afterwards belongs. That is, the PC 50 recognizes the site to which the content delivered via the Internet belongs based on the Web site information (recognition information). Furthermore, it is possible to resolve the correspondence between various keys on the remote controller and processes on the content acquired from the net movie service.

Next, the user selects, for example, a site of a net movie service from a home page which provides various services including a net movie delivery service. The PC executes steps S3 and S4 in FIG. 6. That is, the PC accesses the selected net movie delivery site (step S3), receives a Web page which displays a movie content and displays the received Web page (step S4). A display example of this Web page is shown in FIG. 4, and FIG. 5 shows an example of a display after selecting the content a on the display image in FIG. 4. The operation of the remote controller from FIG. 4 to the display example shown in FIG. 5 is the operation similar to the conventional one using the above described cross key 541 and ENTER key 542, and therefore explanations thereof will be omitted here.

Next, as shown in FIG. 5, in a stage in which the Web page of a specific movie content is displayed, the user operates any one of the PLAY/PAUSE button 543, . . . , BACKWARD SKIP button 548 button of the remote controller 54 shown in FIG. 3. The PC receives the information indicating the contents of the button operation (remote controller operation information) from the remote controller (step 5) and executes step S6 in FIG. 6. That is, the PC refers to the correspondence information (correspondence table in Table 1) based on the URL of the Web page being currently accessed and the remote controller operation information indicating which of the PLAY/PAUSE button 543, . . . , BACKWARD SKIP button 548 has been operated (example of the control information referred to in the present invention) and acquires a script function name associated with the operated button.

Next, the PC executes step S7. That is, the PC judges the presence/absence of the corresponding script function and displays, and when it judges that the corresponding script function does not exist, an error message “the button cannot be used” or the like (step S12) is displayed on, for example, an error message display unit of the PC.

On the other hand, after judging that the corresponding script function has been successfully acquired in step S6 (step S7), the PC judges whether or not the acquired script function is defined in the present Web page (step S8).

The Web page includes a definition of a script function in a form of describing it between <script> and </script> such as: <html><head> . . . (omitted) . . . <script language=“JavaScript”> function RC-play( ) { . . . (process for playback is described here) . . . } . . . (omitted) . . . </script></head><body> . . . (omitted) . . . </body> (/html). This example shows a definition of an RC-play( ) function. The PC judges whether or not the script function, which is identical to the script function extracted from the correspondence table shown in Table 1, is defined in the Web page (step S8).

When the PC 50 judges that the script function extracted from the correspondence table shown in Table 1 is not defined in the present Web page, an error message display unit of the PC displays an error message (step S12). On the other hand, when the PC 50 judges that the script function extracted from the correspondence table shown in Table 1 is defined in the current Web page, it invokes the script function (step S9). That is, the PC 50 invokes the function associated with the control information received from the remote controller 54. The PC 50 executes the corresponding script function, and as a result, changes the display mode of the Web browser which has been executed by the PC (step S10).

This embodiment has shown an example where the script function names of such functions as playing back content that belongs to the net movie service A are different from the script function names of such functions as playing back content that belongs to the net movie service B. In this case, the correspondence between the operation buttons of the remote controller and the script functions is also resolved based on the identification information (URL, or the like) of the net movie service to which the content belongs.

Furthermore, this embodiment is not only easy to realize compared to the mode in which such correspondence information is described in the Web page (in the Web page downloaded in step S4 of FIG. 6), but it also improves safety.

Since a Web page can be freely rewritten by anyone who has acquired the authority as an administrator of the Web site, the information in the Web page may be altered due to fraudulent acts even if it is a legitimate site. That is, there is a possibility that an illegal third party may describe information that associates a script function which executes processing that is obviously different from that of the user's intention with an operation button of the remote controller in the Web page. When, for example, information which associates a script function that executes a billing start processing with the STOP button or the REWIND button or the like of the remote controller is described, billing processing is carried out against the user's intention, causing the user to suffer an economical loss.

This embodiment resolves the correspondence between operation buttons of the remote controller and script functions according to correspondence information acquired beforehand aside from a Web page, and can thereby eliminate the possibility of wrong operations based on illegal correspondence information described in the Web page and improve the safety.

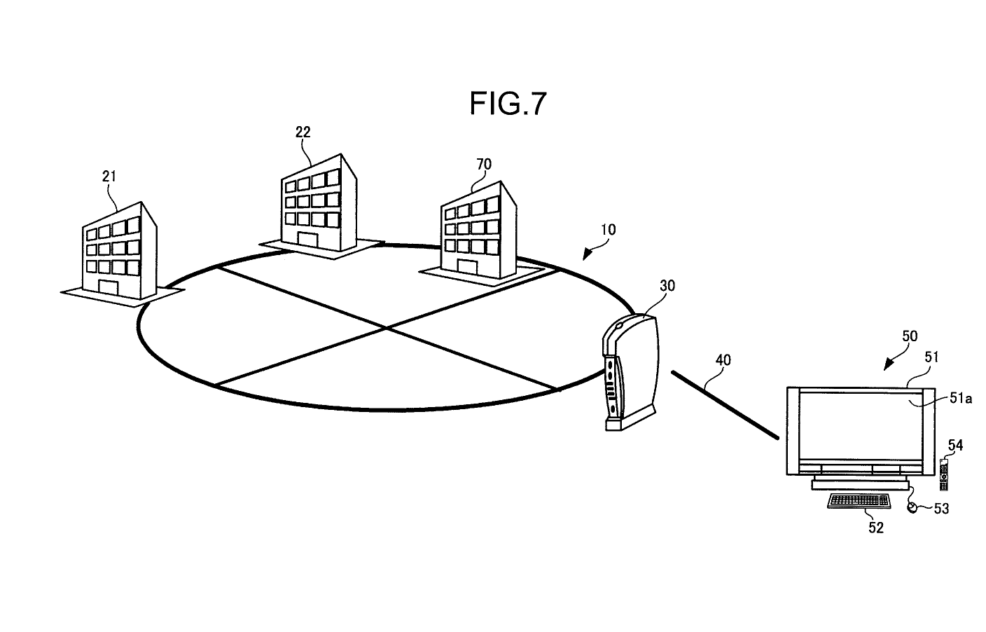

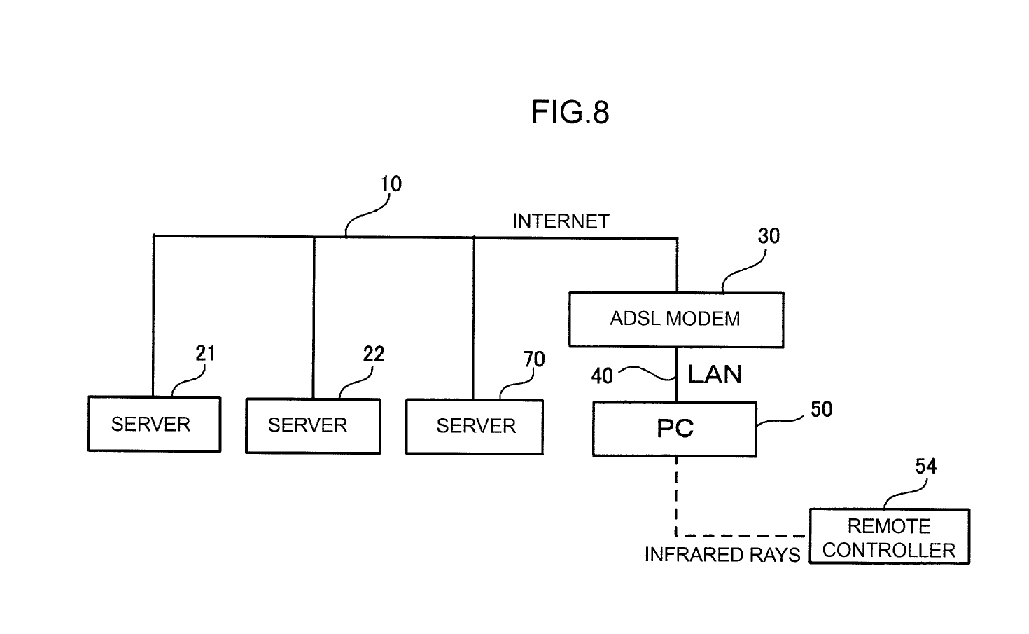

FIG. 7 and FIG. 8 show the overall configuration of a second embodiment of an image display system including a PC which operates as a content processing apparatus of the present invention.

FIG. 7 and FIG. 8 show the same components as those of the image display system shown in FIG. 1 and FIG. 2 by assigning thereto the same reference numerals as those in FIG. 1 and FIG. 2. Hereinafter, only components which are different from those shown in FIG. 1 and FIG. 2 out of the components of the image display system shown in FIG. 7 and FIG. 8 will be explained.

The image display system shown in FIG. 7 and FIG. 8 differs from the image display system shown in FIG. 1 and FIG. 2 in that a server 70 is added. In the aforementioned first embodiment, the information indicating the location of the Web site information of the servers 21, 22 that are providing net movie services is preset in the Web browser executed in the personal computer 50.

On the other hand, in this embodiment, the server 70 manages information indicating locations of various sites which are providing net movie services. The server 70 is always updating the information indicating the locations of the sites. On the other hand, the information indicating the location of the server 70 is preset in the Web browser which is executed in the PC 50. The PC 50 accesses the server 70 to acquire information indicating the location of Web site information. The PC 50 then acquires the Web site information based on the acquired information indicating the location.

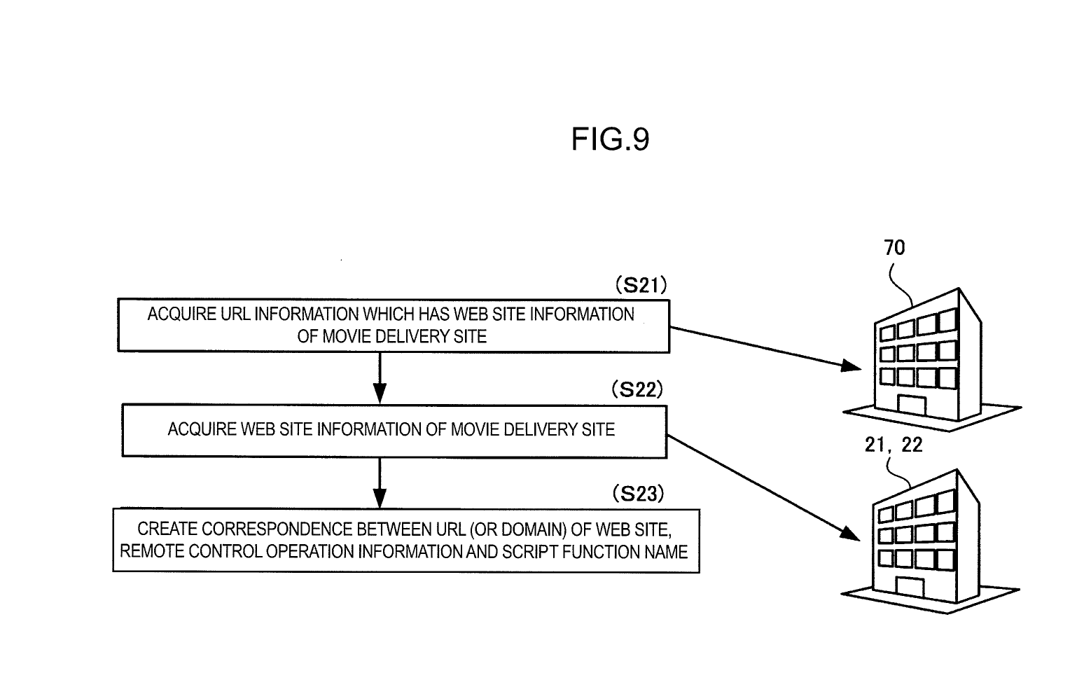

FIG. 9 is a flow chart of parts peculiar to the second embodiment.

This flow chart shows parts which replace step S1 and step S2 of the flow chart of the above described first embodiment shown in FIG. 6.

In this embodiment, a URL of the server 70 is preset in the Web browser in the PC 50. The PC 50 accesses the server 70 and acquires URL information in which the Web site information of the movie delivery site exists (an example of the location information referred to in the present invention) (step S21). Next, the PC 50 accesses the servers 21, 22 based on the URL information and acquires Web site information of movie delivery sites (step S22). Based on this, the PC 50 associates the Web site information (URL or domain of the Web site), operation information of the remote controller and script functions with each other (step S23).

The contents of the Web site information and location of the Web site information may be changed. Especially, when the location of the Web site information is changed, the setting of the Web browser must be updated in the above described first embodiment. On the other hand, in the second embodiment, the server 70 manages the location information of the Web site information. Therefore, when the location of the Web site information is changed, the setting of the Web browser of the PC need not be updated in the second embodiment.

Next, a few examples of modifications of the first and second embodiments will be explained.

The above described embodiments have shown examples where the PC acquires Web site information in a domain name or URL format. On the other hand, when acquiring the Web site information, information on the title of a net movie service, information on an icon which represents the net movie service and URL of a representative (e.g., top) Web page are acquired together as follows: <?xmlversion=“1.0” encoding=“Shift-JIS”?><title> net movie service A</title> <iconUrl>http://www.example.com/vod/icon.png</iconUrl> <url>http://www.example.com/vod/index.html</url> <allowRemoteControlList> <domain>vod.example.com</domain> </allowRemoteControlList>

In the above described example, a title sentence <title> defines a title of a net movie service, a icon sentence <iconUrl> defines a url which represents an icon of the net movie service, and a url sentence <url> defines URL of a net movie service. As in the case of the above described embodiment, a URL sentence <url>http://www.example.com/vod/</url> may be included instead of the sentence of the domain name in this <domain>vod.example.com</domain>.

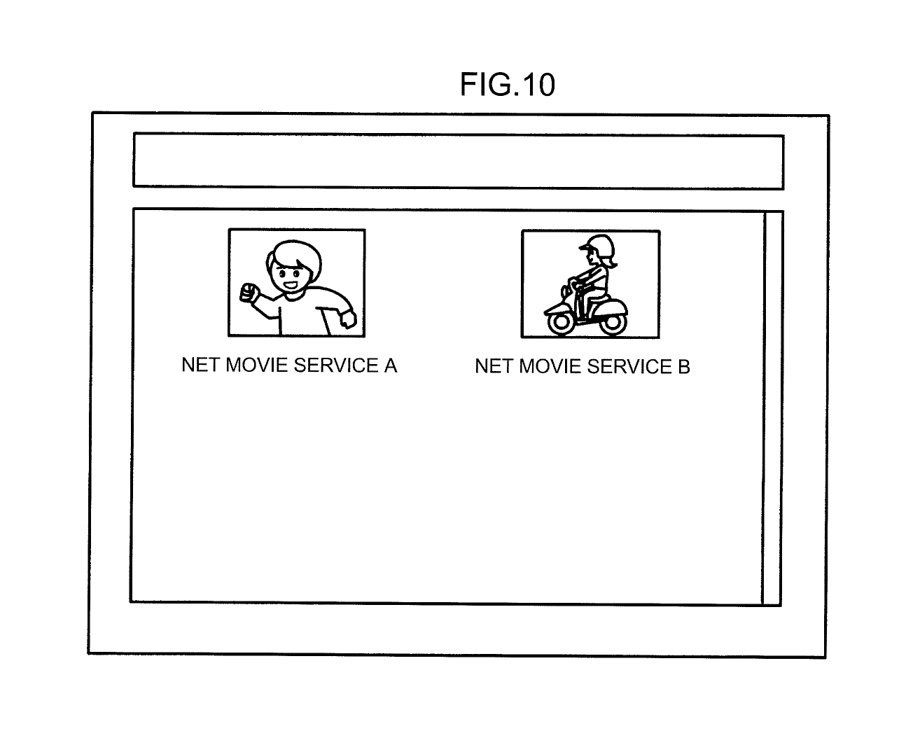

FIG. 10 illustrates a display example when information such as a title is acquired together as described above.

FIG. 10 shows titles of a plurality of (here two) net movie services (“net movie service A” and “net movie service B”) and their icons. When one of these icons is selected, using, for example, the cross key and the ENTER key of the remote controller, the URL associated with the icon is accessed. For example, when the URL of the net movie service A is accessed, the display is directly shifted to the display of the net movie service A shown in FIG. 5.

In the case of this configuration, a desired net movie service can be selected from the list of a plurality of net movie services across a plurality of sites, whereby the convenience improves further.

The following example is an example of a modification related to the correspondence table in Table 1 in the above described embodiment.

The above described embodiment has been explained on the assumption that this correspondence table is originally embedded in the Web browser which is executed in the PC, but it is also possible to acquire the information of this correspondence table through a network and to create a correspondence table based on the information.

Here, when the Web site information is acquired in step S1 in FIG. 6, the following correspondence information is acquired simultaneously with the acquisition of the Web site information: <?xmlversion=“1.0”encoding=“Shift-JIS” ?><allowRemoteControlList><domain>vod.example.com.</domain><url>http://www.example. com./vod/</url> <button> <play>RC-play</Play> <stop>RC-stop</stop><pause>RC-pause</pause><ffwd>RC-ffwd</ffwd> <rwd>RC-rwd</rwd><next>RC-next</next><prev>RC-play</prev></button></allowRemoteControlList> Here, <play> . . . </play> indicates the PLAY button of the remote controller and RC-play interposed between <play> and </play> indicates the script function which corresponds to the PLAY button. The same applies to other correspondence information such as <stop> . . . </stop>, etc.

The above described correspondence information is for the net movie service A (see Table 1) and the following correspondence information is acquired for the net movie service B: <?xmlversion=“1.0”encoding=“Shift-JIS”?><allowRemoteControlList> <domain>vod.example.com.</domain> <url>http://www.example.com./vod/</url> <button> <play>MoviePlay</Play> <stop>MovieStop</stop> <pause>MoviePause</pause> <ffwd>MovieFoward</ffwd> <rwd>MovieRewind</rwd> </button></allowRemoteControlList> In this case, too, compared with the case where correspondence information is embedded in the conventionally proposed Web page itself (Web page acquired in step S4 in FIG. 6), it is possible to secure sufficient safety and flexibly cope with additions and changes, if any, to the script function on the net movie service side.

What is claimed is:

1. A content processing apparatus comprising:
a remote controller including a plurality of operators, wherein the remote controller transmits control information corresponding to an operation to a main unit by wireless connection;
a recognition information acquisition unit acquiring recognition information for recognizing a site to which content delivered via a network belongs;
a site recognition unit recognizing the site to which the content delivered via the network belongs based on the recognition information;
an association unit associating the control information received from the remote controller with a script function of the site according to the recognized site; and
a script function invoking unit invoking a script function associated with the control information received from the remote controller;
wherein the main unit includes a communication interface able to receive the content delivered from the site on the network and that processes the content according to the control information received from the remote controller.

2. The content processing apparatus according to claim 1, wherein the recognition information acquisition unit acquires the recognition information via the network.

3. The content processing apparatus according to claim 1, wherein the recognition information acquisition unit accesses a predetermined site via the network, acquires location information indicating the location of the recognition information from the predetermined site, accesses the predetermined site via the network based on the acquired location information and acquires the recognition information.

4. The content processing apparatus according to claim 1, wherein the recognition information includes part of domain information or a URL of a site.

5. The content processing apparatus according to claim 1, wherein the association unit has a correspondence table in which the control information and script function names are associated with each other for a plurality of sites, and wherein the control information transmitted from the remote controller is associated with the script function of the site.

6. The content processing apparatus according to claim 1, wherein the site recognition unit includes an error message display unit displaying an error message when the site recognition unit cannot recognize a site.

7. The content processing apparatus according to claim 1, further comprising a correspondence information acquisition unit acquiring correspondence information between the control information and script function names via the network.

8. The content processing apparatus according to claim 1, wherein the recognition information acquisition unit acquires the recognition information and acquires site access information to directly access the site specified by the recognition information, and
the content processing apparatus further includes a site access information display unit displaying the site access information.

9. The content processing apparatus according to claim 1, wherein the script function invoking unit invokes a script function associated with the control information transmitted from the remote controller only when the script function is defined in the current web page for display.

10. A recording medium upon which is recorded a content processing program, the content processing program comprising:
a recognition information acquisition step of acquiring recognition information for recognizing a site to which a content delivered via the network belongs;
a site recognition step of recognizing a site to which the content delivered via the network belongs based on the recognition information;
an association step of associating the control information received from the remote controller with a script function of the site according to the recognized site;
a script function invoking step of invoking a script function associated with the control information received from the remote controller; and
a control information transmission step of transmitting control information corresponding to an operation from a remote controller, which includes a plurality of operators, to a main unit by wireless connection;
wherein the main unit includes a communication interface able to receive the content delivered from the site on the network and processes the content according to the control information received from the remote controller.

11. The recording medium including the content processing program according to claim 10, wherein the recognition information acquisition step acquires the recognition information via the network.

12. The recording medium including the content processing program according to claim 10, wherein the recognition information acquisition step accesses a predetermined site via the network, acquires location information indicating the location of the recognition information from the predetermined site, accesses via the network based on the acquired location information and acquires the recognition information.

13. The recording medium including the content processing program according to claim 10, wherein the recognition information includes part of domain information or a URL of a site.

14. The recording medium including the content processing program according to claim 10, wherein the association step involves a correspondence table in which the control information and script function names are associated with each other for a plurality of sites and the control information transmitted from the remote controller is associated with the script function of the site.

15. The recording medium including the content processing program according to claim 10, wherein the site recognition step includes an error message display step of displaying an error message when the site recognition step does not recognize a site.

16. The recording medium including the content processing program according to claim 10, further comprising a correspondence information acquisition step of acquiring correspondence information between the control information and script function names via the network.

17. The recording medium including the content processing program according to claim 10, wherein the recognition information acquisition step acquires the recognition information and acquires site access information to directly access the site specified by the recognition information, and
the content processing program further includes a site access information display step for displaying the site access information.

18. The recording medium including content processing program according to claim 10, wherein the script function invoking step invokes a script function associated with the control information transmitted from the remote controller only when the script function is defined in the current web page for display.
